(19) United States
(12) Patent Application Publication
(10) Pub. No.: US 2024/0156318 A1
(43) Pub. Date: May 16, 2024

(54) VACUUM CLEANER

(71) Applicant: Conet Industries Inc., Incheon (KR)

(72) Inventor: Sung Wook Song, Seoul (KR)

(73) Assignee: Conet Industries Inc., Incheon (KR)

(21) Appl. No.: 18/308,249

(22) Filed: Apr. 27, 2023

(30) Foreign Application Priority Data
Nov. 10, 2022 (KR) 10-2022-0149126

(51) Int. Cl. A47L 9/20; A47L 5/36; A47L 9/12; A47L 9/14; A47L 9/16; A47L 9/22; A47L 9/26; A47L 9/32; B01D 46/00; B01D 46/10; B01D 46/24; B01D 46/42; B01D 46/62

(52) U.S. Cl. CPC A47L 9/20; A47L 5/365; A47L 9/122; A47L 9/125; A47L 9/1409; A47L 9/1463; A47L 9/1608; A47L 9/165; A47L 9/1666; A47L 9/1683; A47L 9/22; A47L 9/26; A47L 9/327; B01D 46/0004; B01D 46/0006; B01D 46/0036; B01D 46/0038; B01D 46/0042; B01D 46/0043; B01D 46/103; B01D 46/2403; B01D 46/4227; B01D 46/62; B01D 2265/06; B01D 2267/40; B01D 2273/30; B01D 2275/10; B01D 2275/201; B01D 2279/55

(57) ABSTRACT

Disclosed is a vacuum cleaner. In the disclosed vacuum cleaner, a dust container includes a casing which has one open side and in which a suction port is formed in a circumferential surface of the casing, a filter unit which is provided in the casing, allows air introduced through the suction port to pass, and filters out foreign matter contained in the air, and an inlet guide member which is provided on an inner surface of the casing corresponding to one edge of the suction port so that the air introduced through the suction port generates a vortex to guide foreign matter having a predetermined size or larger among the foreign matter to fall to an inner bottom of the casing and to guide foreign matter attached to a surface of the filter unit to be detached.

### CROSS-REFERENCE TO RELATED APPLICATION

This application claims priority to and the benefit of Korean Patent Application No. 2022-0149126, filed on Nov. 10, 2022, the disclosure of which is incorporated herein by reference in its entirety.

### BACKGROUND

### 1. Field of the Invention

The present invention relates to a vacuum cleaner, and more specifically, to a vacuum cleaner in which a filter having various functions is installed on a corn type protector having an upper portion having a large diameter, the protector is fixedly mounted inside a dust container, foreign matter and air flowing into the dust container are guided to flow in a circumferential direction of the protector to allow purified air to pass through the filter while minimizing attachment of the foreign matter to the filter, and a discharge port for the purified air is formed in a circumferential surface of a casing of the dust container or a housing of an operating part to prevent the air from directly blowing to a user and improve satisfaction of the user.

### 2. Discussion of Related Art

In the general conventional vacuum cleaner, a vacuum generating motor and an envelope type filter are installed in a body of the cleaner, and sludge is introduced into the body of the cleaner by a vacuum force generated when the motor is driven and is filtered using a filter so that foreign matter remains in the cleaner body and only the sludge and air having passed through the filter are discharged through a discharge port installed in an upper portion of the body.

Particularly, the vacuum cleaner suctions and removes dust or foreign matter using a suction force for introducing air into the vacuum cleaner from the outside when the motor embedded in the main body is driven and is generally used to clean a floor.

Such vacuum cleaners are largely divided into canister type vacuum cleaners in which a suction nozzle for suctioning dust from a floor is provided separately from a main body and is replaceable with a suction nozzle suitable for a use according to a place of use and upright type vacuum cleaners in which a suction nozzle is integrally formed with a main body.

The canister type vacuum cleaner includes the main body which generates a suction force and collects dust, a suction nozzle which suctions the dust and foreign matter while in contact with and moving on a floor, and a connecting pipe for connecting the suction nozzle to the main body. In the canister type vacuum cleaner, the suction nozzle can be replaced according to a shape, a material, and the like of an object or floor to be cleaned, the suction force is strong, and a use range is wider than that of the upright type vacuum cleaner.

In addition, in the upright type vacuum cleaner, since the suction nozzle and a grip are integrally provided with the main body, the upright type vacuum cleaner is easily moved and used, and thus mainly used when relatively simple cleaning is performed.

A vacuum cleaner has been proposed in Korean Patent Publication No. 10-2012-0114132 (Title of invention: SUCTION PIPE FOR VACUUM CLEANER AND VACUUM CLEANER HAVING THE SAME).

The above-described technical configuration is the related art for helping with understanding of the present invention, and this does not mean that it is the related art widely known in the art to which the present invention belongs.

### SUMMARY OF THE INVENTION

Existing vacuum cleaners have a problem that air from which foreign matter such as dust is filtered out is discharged upward and flows toward a user, causing displeasure for the user. In addition, the existing vacuum cleaners have problems that the foreign matter gathers on a surface of a filter unit which filters out the foreign matter, and flow resistance of the air from which the foreign matter is filtered out increases, which generates much noise and decreases air purification efficiency.

Therefore, there is a need to improve existing vacuum cleaners.

The present invention is intended to solve the above-described problems and directed to providing a vacuum cleaner in which a filter having various functions is installed on a corn type protector having an upper portion having a large diameter and the protector is fixedly mounted inside a dust container and foreign matter and air flowing into the dust container are guided to flow in a circumferential direction of the protector to allow purified air to pass through the filter while minimizing attachment of the foreign matter to the filter.

The present invention is also directed to providing a vacuum cleaner in which a discharge port for purified air is formed in a circumferential surface of a casing of a dust container or a housing of an operating part to prevent the air from directly blowing to a user and improve satisfaction of the user.

According to an aspect of the present invention, there is provided a vacuum cleaner including a dust container which includes a suction port and filters foreign matter out of air, wherein the air containing the foreign matter is introduced through the suction port and an operating part which is separably provided in the dust container and forcibly guides an air flow.

The dust container may include a casing which has one open side and in which the suction port is formed in a circumferential surface of the casing, a filter unit which is provided in the casing, allows the air introduced through the suction port to pass, and filters out the foreign matter contained in the air, and an inlet guide member which is provided on an inner surface of the casing corresponding to one edge of the suction port so that the air introduced through the suction port generates a vortex to guide foreign matter having a predetermined size or larger among the foreign matter to fall to an inner bottom of the casing and to guide foreign matter attached to a surface of the filter unit to be detached.

The operating part may include a housing which blocks the open side of the casing and a motor member which is provided in the housing and guides a forced flow of the air inside the casing and the housing.

The casing or the housing may include a discharge port in a circumferential surface of one side of the casing or the housing to discharge the air which passes through and is purified by the filter unit.

The filter unit may include a protector which is connected to the operating part or the casing, is formed of a hard material to maintain a shape of the protector, and is formed in a mesh or lattice shape to allow the air to pass therethrough and of which a diameter increases in a height direction from a bottom of the casing to secure a space in which the foreign matter is stored on the inner bottom of the casing, a filter member which is in surface contact with and supported by at least one of an inner side and an outer side of the protector to maintain a shape of the filter member and filters out the introduced foreign matter, and a mounting part which fixedly supports the protector and the filter member surrounding the outer side of the protector in the casing.

In the protector, a slope of a circumferential surface corresponding to the inlet guide member may be different from a slope of a circumferential surface which does not face the inlet guide member in order to secure an amount of air flowing through a space between the inlet guide member and the protector

The filter member may include one or more high-efficiency particulate air (HEPA) filters which cover the outer side of the protector relatively close to the suction port, are formed to correspond to a shape of the protector, and filter out fine foreign matter flowing with the air and one or more activated carbon filters which are seated inside the protector and are formed to correspond to the shape of the protector to filter out ultra-fine foreign matter and an odor component contained in the foreign matter.

The HEPA filter may include a gripper protruding outward while in contact with an edge of the open side of the casing when the casing and the housing are coupled.

The housing may include an outer housing which is separably coupled to the open side of the casing and includes a motor member therein and in which a discharge port is formed in a circumferential surface of the outer housing, an inner housing which has a diameter smaller than a diameter of the outer housing, is fixedly provided in the outer housing, and allows the filtered air to be introduced through the other open side in a central axis direction and in which a connecting hole is formed in a circumferential surface of the inner housing, and a flow passage formed between an inner circumferential surface of the outer housing and an outer circumferential surface of the inner housing to guide the air introduced through the connecting hole to be discharged through the discharge port.

The housing may include a body which is coupled to an air inlet side of the outer housing or the inner housing and in which a discharge hole is formed and a motor member is fixedly installed to correspond to the discharge hole and a discharge filter module which is installed in the outer housing to correspond to the discharge port to purify exhausted air and prevent external foreign matter from being introduced into the outer housing.

The discharge filter module may include a frame which is slide-inserted into the discharge port to a set depth and formed to allow air to pass, one or more foreign matter filters provided inside the frame, and an odor filter which is provided on at least one of an inlet side and an outlet side of the frame, through which air in the outer housing is introduced, to filter out particles and an odor material generated when the motor member is driven.

The discharge filter module may include a cover separably coupled to the outer housing to allow air to flow and prevent the frame from being separated from the discharge port due to flow resistance of the exhausted air.

The frame may include a knob to be gripped when taken out of the discharge port.

The outer housing may include a rotary reel which is rotatable in an inner space partitioned from the inner housing, and the rotary reel may be rotated using a handle and wind a cable which is withdrawn.

The outer housing may include a pivoting grip.

The housing may include a guide roller at an inner side corresponding to an outlet hole to guide the cable.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view illustrating a vacuum cleaner according to one embodiment of the present invention;

FIG. 2 is a perspective view illustrating a state in which a cleaning hose of the vacuum cleaner according to one embodiment of the present invention is mounted;

FIG. 3 is an exploded perspective view illustrating a state in which a dust container and an operating part of a vacuum cleaner according to one embodiment of the present invention are separated;

FIG. 4 is an exploded perspective view illustrating a filter unit of the operating part according to one embodiment of the present invention;

FIG. 5 is an exploded bottom perspective view illustrating the filter unit according to one embodiment of the present invention;

FIG. 6 is an exploded perspective view illustrating a discharge filter module of the operating part according to one embodiment of the present invention;

FIG. 7 is an exploded rear perspective view illustrating the discharge filter module according to one embodiment of the present invention;

FIG. 8 is a cross-sectional view illustrating the vacuum cleaner along line A-A of FIG. 1;

FIG. 9 is a cross-sectional view illustrating the vacuum cleaner along line B-B of FIG. 1;

FIG. 10 is a vertical cross-sectional view illustrating the vacuum cleaner according to one embodiment of the present invention; and

FIG. 11 is a perspective view illustrating main parts guiding a cable inserted into the vacuum cleaner according to one embodiment of the present invention.

### DETAILED DESCRIPTION OF EXEMPLARY EMBODIMENTS

Hereinafter, embodiments of a vacuum cleaner according to the present invention will be described with reference to the accompanying drawings. While the vacuum cleaner is described, thicknesses of lines, sizes of components, or the like illustrated in the drawings may be exaggerated for clarity and convenience for the description. In addition, some terms described below are defined in consideration of functions in the invention, and meanings thereof may vary depending on a user or operator's intentions or customs. Therefore, the meanings of terms should be defined based on the content throughout this specification.

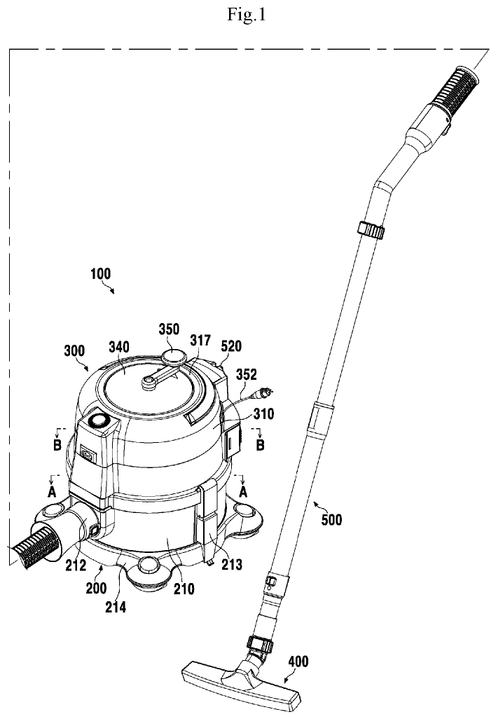

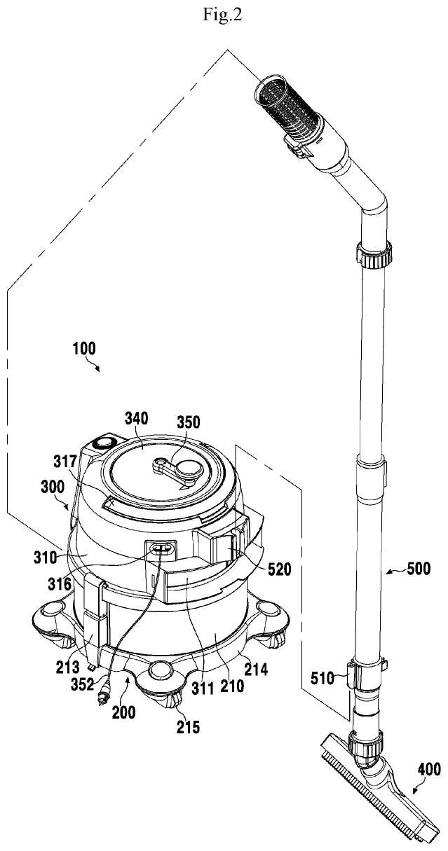

FIG. 1 is a perspective view illustrating a vacuum cleaner according to one embodiment of the present invention, and FIG. 2 is a perspective view illustrating a state in which a cleaning hose of the vacuum cleaner according to one embodiment of the present invention is mounted.

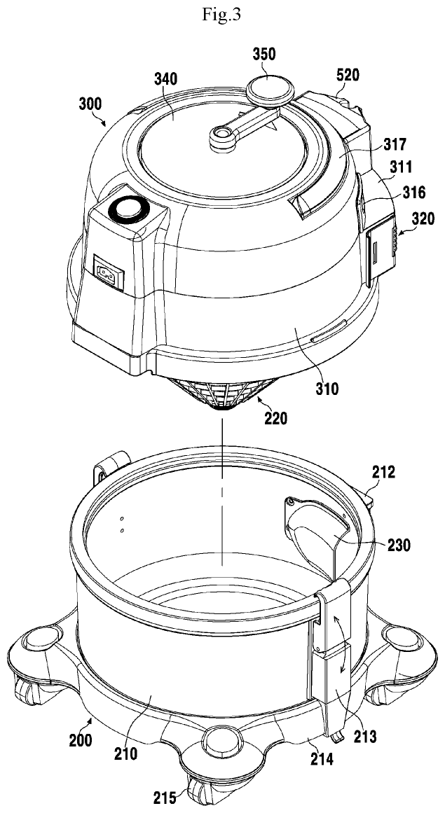

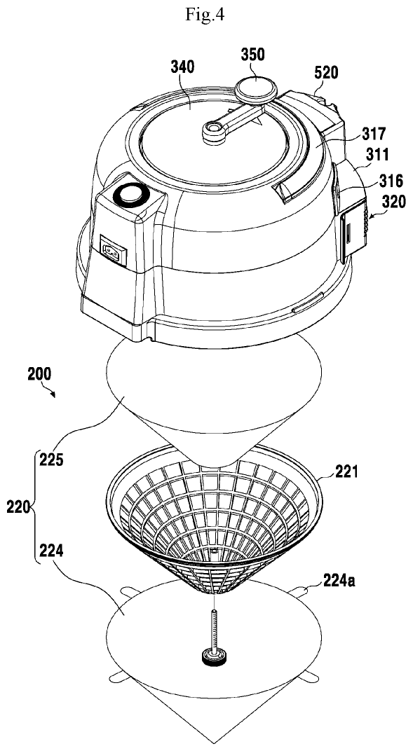

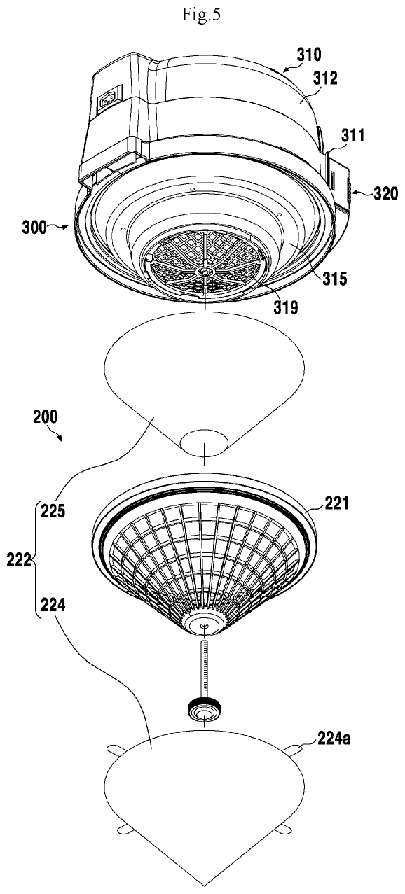

FIG. 3 is an exploded perspective view illustrating a state in which a dust container and an operating part of a vacuum cleaner according to one embodiment of the present invention are separated, FIG. 4 is an exploded perspective view illustrating a filter unit of the operating part according to one embodiment of the present invention, and FIG. 5 is an exploded bottom perspective view illustrating the filter unit according to one embodiment of the present invention.

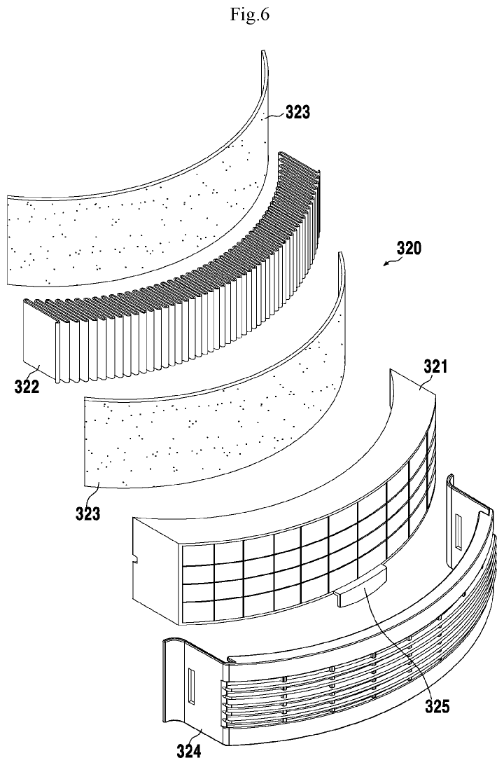

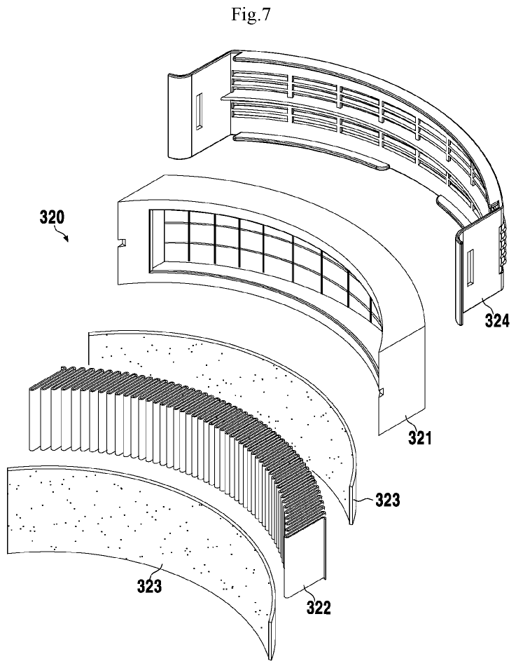

FIG. 6 is an exploded perspective view illustrating a discharge filter module of the operating part according to one embodiment of the present invention, and FIG. 7 is an exploded rear perspective view illustrating the discharge filter module according to one embodiment of the present invention.

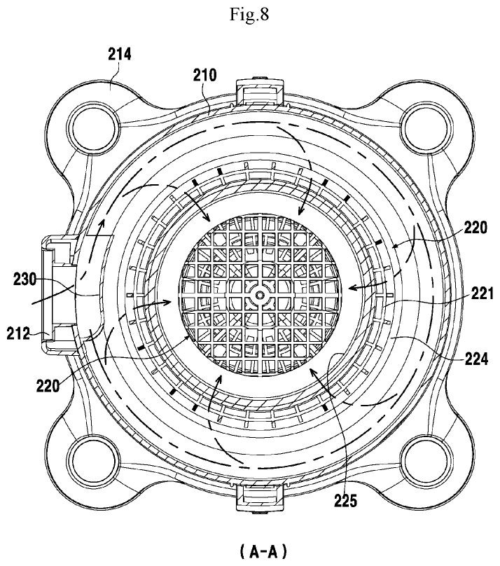

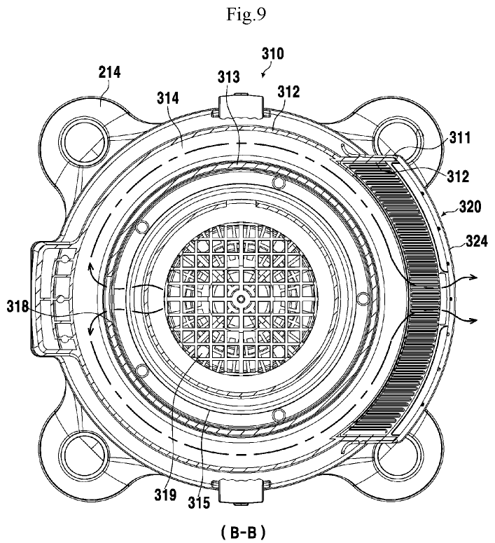

FIG. 8 is a cross-sectional view illustrating the vacuum cleaner along line A-A of FIG. 1, and FIG. 9 is a cross-sectional view illustrating the vacuum cleaner along line B-B of FIG. 1.

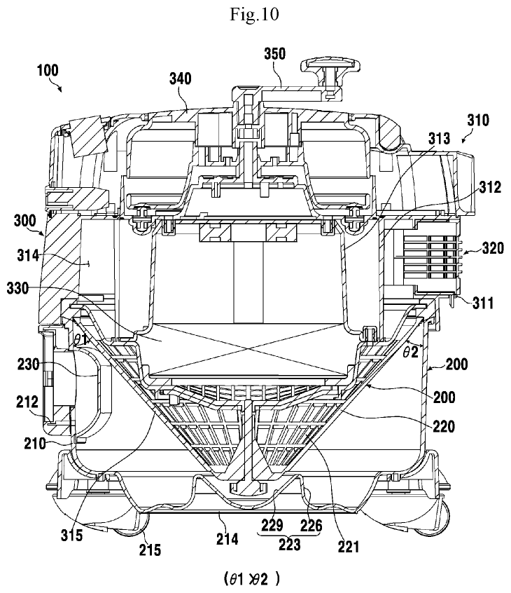

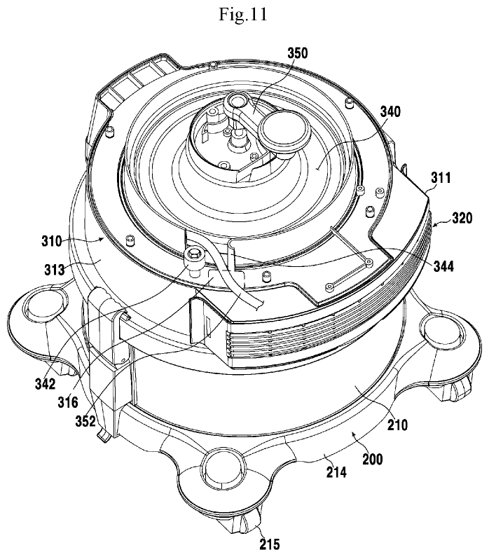

FIG. 10 is a vertical cross-sectional view illustrating the vacuum cleaner according to one embodiment of the present invention, and FIG. 11 is a perspective view illustrating main parts guiding a cable inserted into the vacuum cleaner according to one embodiment of the present invention.

Referring to FIGS. 1 to 11, a vacuum cleaner 100 according to one embodiment of the present invention includes a dust container 200, an operating part 300, a cleaning nozzle assembly 400, and a cleaning hose 500.

The dust container 200 includes a suction port 212 through which air containing foreign matter enters, and serves to filter out the foreign matter from the air. The filtered foreign matter is stored in the dust container 200.

In addition, the operating part 300 is separably provided in the dust container 200 and forcibly guides a flow of air.

In addition, the cleaning nozzle assembly 400 serves to suction foreign matter such as dust on a floor with air when the operating part 300 operates.

The cleaning hose 500 connects the dust container 200 and the cleaning nozzle assembly 400 and serves to guide foreign matter and air suctioned into the cleaning nozzle assembly 400 to be transferred to the dust container 200.

Specifically, the dust container 200 includes a casing 210, a filter unit 220, and an inlet guide member 230.

The casing 210 constitutes an exterior of the dust container 200 and is a container for storing foreign matter filtered out of air. In this case, the casing 210 is formed to be open toward one side.

However, the casing 210 may be formed in one of various shapes and of one of various materials.

Particularly, the suction port 212 is formed in a circumferential surface of the casing 210. The suction port 212 is formed to be separably connected to the cleaning hose 500.

In addition, the casing 210 is fixedly seated on a carrier 214, and the carrier 214 includes a plurality of rollers 215. Accordingly, the casing 210 moves easily. A shape of the carrier 214 may be changed to one of various shapes, and the rollers 215 are fixedly installed in one of various manners.

In addition, the filter unit 220 is provided in the casing 210, allows air introduced into the suction port 212 to pass therethrough, and filters out foreign matter contained in the air.

In this case, the filter unit 220 may be separably coupled to the casing 210 or separably coupled to the operating part 300. For the sake of convenience, it is assumed that the filter unit 220 is separably coupled to the operating part 300.

In addition, the inlet guide member 230 is provided on an inner surface of the casing 210 corresponding to one edge of the suction port 212 so that air introduced through the suction port 212 generates a vortex to guide foreign matter and the like having a predetermined size or larger among foreign matter to fall to an inner bottom of the casing 210 and to guide foreign matter attached to a surface of the filter unit 220 to be detached by air flowing along a set trajectory.

In this case, the inlet guide member 230 discharges and guides air and foreign matter so that the air flows in a circumferential direction in the casing 210, and may be formed in one of various shapes. In addition, the inlet guide member 230 may be integrally manufactured with the casing 210 or may be separably coupled to the casing 210. The inlet guide member 230 is provided to protrude inward from the casing 210.

Particularly, the filter unit 220 includes a protector 221, a filter member 222 and a mounting part 223.

The protector 221 is fixedly connected to the operating part 300 or the casing 210, is formed of a hard material to maintain its shape, and is formed in a mesh or lattice shape to allow air to pass therethrough.

In addition, the protector 221 is formed so that a diameter of the protector 221 increases in a height direction from a bottom of the casing 210 in order to secure a space in which foreign matter is stored and a space in which air flows in the circumferential direction on the inner bottom of the casing 210. For the sake of convenience, the protector 221 is illustrated as having a downward cone shape in which an upper portion is wide and a lower portion is narrow. In this case, the upper portion of the protector 221 has a size which covers an entire lower portion of the operating part 300.

The filter member 222 is in surface contact with and supported by any one of an inner side and an outer side of the protector 221 to maintain the shape of the filter member 222 and serves to filter out introduced foreign matter.

As an example, the filter member 222 includes a high-efficiency particulate air (HEPA) filter 224 and an activated carbon filter 225.

The HEPA filter 224 surrounds the outer side of the protector 221 relatively close to the suction port 212 and is formed to correspond to the shape of the protector 221 to filter out fine foreign matter flowing with air.

In this case, the HEPA filter 224 is provided to have one or more layers. The HEPA filter 224 is formed to correspond to an outer shape of the protector 221.

In addition, the activated carbon filter 225 is seated inside the protector 221 and is formed to correspond to the shape of the protector 221 to filter out ultra-fine foreign matter and odor components contained in the foreign matter. The activated carbon filter 225 is provided to have one or more layers and is formed to correspond to an inner shape of the protector 221.

In this case, as the inlet guide member 230 protrudes inward from the casing 210, a straight distance between the filter unit 220, particularly the activated carbon filter 225, and the inlet guide member 230 is smaller than a straight distance between the inner surface of the casing on which the inlet guide member 230 is not formed and the activated carbon filter 225. Accordingly, as flow resistance of the air and flow resistance of the foreign matter become different, noise may be generated.

Accordingly, in the protector 221 configured to maintain the shape of the HEPA filter 224, a slope θ1 of a circumferential surface corresponding to the inlet guide member 230 and a slope θ2 of a circumferential surface which does not face the inlet guide member 230 are different to secure an amount of air flowing through a space between the inlet guide member 230 and the protector 221

That is, in the protector 221, the slope θ1 of the circumferential surface corresponding to the inlet guide member 230 is greater than the slope θ2 of the circumferential surface which does not face the inlet guide member 230 (slope θ1>slope θ2).

In addition, as the filter member 222, particularly the HEPA filter 224, surrounds the outer side of the protector 221, the HEPA filter 224 may flutter at a predetermined distance from the protector 221.

In order to prevent this, the HEPA filter 224 surrounding an outer surface of the protector 221 is fixedly pressed by the operating part 300 in a state in which an upper side of the protector 221 is in contact with an edge of an open side of the casing 210. In addition, the HEPA filter 224 includes a gripper 224a protruding outward while in contact with the edge of the open side of the casing 210 when the casing 210 and a housing 310 of the operating part 300 are coupled.

The gripper 224a is configured such that the HEPA filter 224 can be easily held and taken out of the casing 210 when the casing 210 and the housing 310 are separated. However, the shape of the gripper 224a may be changed to one of various shapes.

In addition, in the casing 210, the mounting part 223 fixedly supports the protector 221 and the HEPA filter 224 of the filter member 222 surrounding the outer side of the protector 221.

In this case, the mounting part 223 includes a mounting protrusion 226 and a mounting groove 229.

The mounting protrusion 226 protrudes from the inner bottom of the casing 210 to correspond to a pointed shape of the lower portion of the protector 221.

In addition, the mounting groove 229 is formed to be recessed in the mounting protrusion 226 to accommodate the lower portion of the protector 221.

Accordingly, the mounting groove 229 of the mounting protrusion 226 serves to fixedly support a lower side of the protector 221 and a lower side of the HEPA filter 224. That is, as the lower side of the protector 221 and the lower side of the HEPA filter 224 are accommodated in the mounting groove 229, movement of the protector 221 according to generation of an air flow is prevented.

However, the mounting protrusion 226 may be integrated with the casing 210 or may be separably coupled to the casing 210.

Meanwhile, the operating part 300 includes the housing 310 and a motor member 330.

The housing 310 blocks the open side of the casing 210.

In addition, the motor member 330 is provided in the housing 310 and forcibly controls an air flow in the casing 210 and the housing 310. In this case, one of various members, such as a fan motor, may be applied as the motor member 330.

Particularly, purified air from which foreign matter has been filtered out is exhausted into the atmosphere through a discharge port 311. In this case, the discharge port 311 is formed in a circumferential surface of one side of the casing 210 or the housing 310. For the sake of convenience, the discharge port 311 is formed in the circumferential surface of one side of the housing 310.

In this case, the housing 310 includes an outer housing 312, an inner housing 313, and a flow passage 314.

The outer housing 312 is separably coupled to the open side of the casing 210. In this case, the outer housing 312 is separably coupled to the casing 210 using a clamp 213. Accordingly, a lower portion of the outer housing 312 facing the open side of the casing 210 is formed to be open. However, one of various clamps may be applied as the clamp 213.

In addition, the motor member 330 is provided in the outer housing 312, and the discharge port 311 is formed in a circumferential surface of the outer housing 312. Accordingly, air flows in through the lower portion of the outer housing 312 and then is discharged through the discharge port 311 in the circumferential surface.

Accordingly, the inner housing 313 is provided to change a flow direction of air.

A diameter of the inner housing 313 is smaller than a diameter of the outer housing 312, and the inner housing 313 is fixedly provided in the outer housing 312. In addition, the inner housing 313 allows filtered air to be introduced through the other side (lower side) which is open in a central axis direction.

In this case, a space between a lower side of the outer housing 312 and the lower side of the inner housing 313 is blocked. Accordingly, purified air passing through the filter unit 220 in the casing 210 flows into the inner housing 313. In addition, a connecting hole 318 is formed in a circumferential surface of the inner housing 313.

In addition, the flow passage 314 is formed between an inner circumferential surface of the outer housing 312 and an outer circumferential surface of the inner housing 313 in a state in which the inner housing 313 is axially inserted into the outer housing 312.

Accordingly, air is introduced through the lower side of the inner housing 313 and then exhausted to the outside through the discharge port 311 while flowing between the outer housing 312 and the inner housing 313 through the connecting hole 318. To this end, an upper side and a lower side of the flow passage 314 are blocked.

In addition, the housing 310 includes a body 315 and a discharge filter module 320.

The body 315 is coupled to an air inlet side of the outer housing 312 or the inner housing 313, and a discharge hole 319 is formed in the body 315. Accordingly, a total amount of air passing through the filter unit 220 is introduced into the inner housing 313 after passing through the discharge hole 319.

In this case, the motor member 330 may be fixedly installed in the body 315 to correspond to the discharge hole 319. A shape of the body 315 may be changed to one of various shapes.

In addition, the outer housing 312 includes a rotary reel 340 configured to be rotatable in an upper space of an inner portion of the outer housing 312 partitioned from the inner housing 313, and the rotary reel 340 may be rotated by a handle 350 to wind a cable 352 which is withdrawn.

In this case, an outlet hole 316 is formed in the outer housing 312 to guide the cable 352 connected to the motor member 330 to be withdrawn to the outside.

In addition, a guide roller 342, which is configured to be rotatable, is provided inside the housing 310, particularly the outer housing 312 or the inner housing 313, corresponding to the outlet hole 316 to guide the cable 352. Particularly, when the rotary reel 340 is rotated to pull and wind the cable 352, the cable 352 is transferred while coming into contact with the guide roller 342, and thus transfer friction is minimized. In addition, as the guide roller 342 provides tension to the cable 352 inserted into the housing 310, the cable 352 is wound and aligned around the rotary reel 340 in a taut state, and thus winding defects such as twisting of the cable 352 are prevented.

In addition, a curved guide part 344 is formed inside the outer housing 312 or the inner housing 313 corresponding to the outlet hole 316. The curved guide part 344 is formed to be curved and serves to set a winding direction while reducing frictional resistance of the cable 352 inserted into the housing 310.

In addition, the outer housing 312 may include a pivoting or folding type grip 317 so that the vacuum cleaner 100 can be easily carried.

However, the handle 350 and the grip 317 may each have one of various shapes.

In addition, the discharge filter module 320 is installed in the outer housing 312 to correspond to the discharge port 311 to purify exhausted air once more and prevents foreign matter from being introduced into the outer housing 312.

In this case, the discharge filter module 320 includes a frame 321, a foreign matter filter 322, an odor filter 323, and a cover 324.

The frame 321 is slide-inserted into the discharge port 311 to a set depth and is formed to allow air to pass therethrough. The frame 321 may have one of various shapes.

In addition, one or more foreign matter filters 322 are provided inside the frame 321. In this case, various filters may be applied as the foreign matter filters 322.

The odor filter 323 is provided at at least one of an inlet side and an outlet side of the frame 321, through which air in the outer housing 312 is introduced, and filters out particles and odor materials generated when the motor member 330 is driven. The odor filter 323 is fixed to the frame 321 in one of various manners

However, a position of the foreign matter filter 322 and a position of the odor filter 323 may also be interchanged.

In addition, the cover 324 is separably coupled to the outer housing 312 while supporting the frame 321 to allow an air flow and prevent the frame 321 from being separated from the discharge port 311 by flow resistance of exhaust air.

The cover 324 may be formed in one of various shapes and separably coupled to the outer housing 312 in one of various manners.

Particularly, the frame 321 may include a knob 325 configured to be gripped when taken out of the discharge port 311. A shape of the knob 325 may be changed to one of various shapes.

In this case, the cleaning hose 500 or the cleaning nozzle assembly 400 includes a holding protrusion 510, and the outer housing 312 of the housing 310 or the casing 210 includes a holding port 520 in which the holding protrusion 510 may be fixedly mounted.

Accordingly, when the cleaning nozzle assembly 400 is not used, the cleaning nozzle assembly 400 is stored while mounted on the outer housing 312 or the holding protrusion 510.

However, a shape of each of the holding protrusion 510 and the holding port 520 may be changed to one of various shapes.

As described above, unlike the related art, in a vacuum cleaner according to the present invention, a filter having various functions is installed on a corn type protector having an upper portion having a large diameter, the protector is fixedly mounted inside a dust container and foreign matter and air flowing into the dust container are guided to flow in a circumferential direction of the protector, and thus purified air can pass through the filter while attachment of the foreign matter to the filter is minimized.

According to the present invention, a discharge port for purified air is formed in a circumferential surface of a casing of a dust container or a housing of an operating part to prevent the air from directly blowing to a user, and thus satisfaction of the user can be improved.

According to the present invention, since the size of a dust container and an operating part is significantly reduced in an assembled state compared to the conventional case, movement is easy, and thus satisfaction of a user can be maximized.

While the present invention has been described with reference to embodiments illustrated in the accompanying drawings, the embodiments should be considered in a descriptive sense only, and it will be understood that various alterations and equivalent other embodiments may be made by those skilled in the art. Therefore, the scope of the invention should be defined by the appended claims.

What is claimed is:

1. A vacuum cleaner comprising:
a dust container which includes a suction port and filters foreign matter out of air, wherein the air containing the foreign matter is introduced through the suction port; and
an operating part which is separably provided in the dust container and forcibly guides an air flow,
wherein the dust container includes a casing which has one open side and in which the suction port is formed in a circumferential surface of the casing, a filter unit which is provided in the casing, allows the air introduced through the suction port to pass, and filters out the foreign matter contained in the air, and an inlet guide member which is provided on an inner surface of the casing corresponding to one edge of the suction port so that the air introduced through the suction port generates a vortex to guide foreign matter having a predetermined size or larger among the foreign matter to fall to an inner bottom of the casing and to guide foreign matter attached to a surface of the filter unit to be detached,
the operating part includes a housing which blocks the open side of the casing and a motor member which is provided in the housing and guides a forced flow of the air inside the casing and the housing, and
the casing or the housing includes a discharge port in a circumferential surface of one side of the casing or the housing to discharge the air which passes through and is purified by the filter unit.

2. The vacuum cleaner of claim 1, wherein the filter unit includes:
a protector which is connected to the operating part or the casing, is formed of a hard material to maintain a shape of the protector, and is formed in a mesh or lattice shape to allow the air to pass therethrough and of which a diameter increases in a height direction from a bottom of the casing to secure a space in which the foreign matter is stored on the inner bottom of the casing;
a filter member which is in surface contact with and supported by at least one of an inner side and an outer side of the protector to maintain a shape of the filter member and filters out the introduced foreign matter; and
a mounting part which fixedly supports the protector and the filter member surrounding the outer side of the protector in the casing.

3. The vacuum cleaner of claim 2, wherein, in the protector, a slope of a circumferential surface corresponding to the inlet guide member is different from a slope of a circumferential surface which does not face the inlet guide member in order to secure an amount of air flowing through a space between the inlet guide member and the protector.

4. The vacuum cleaner of claim 2, wherein the filter member includes:
one or more high-efficiency particulate air (HEPA) filters which cover the outer side of the protector relatively close to the suction port, are formed to correspond to a shape of the protector, and filter out fine foreign matter flowing with the air; and
one or more activated carbon filters which are seated inside the protector and are formed to correspond to the shape of the protector to filter out ultra-fine foreign matter and an odor component contained in the foreign matter.

5. The vacuum cleaner of claim 4, wherein the HEPA filter includes a gripper protruding outward while in contact with an edge of the open side of the casing when the casing and the housing are coupled.

6. The vacuum cleaner of claim 1, wherein the housing includes:
an outer housing which is separably coupled to the open side of the casing and includes a motor member therein and in which a discharge port is formed in a circumferential surface of the outer housing;
an inner housing which has a diameter smaller than a diameter of the outer housing, is fixedly provided in the outer housing, and allows the filtered air to be introduced through the other open side in a central axis direction and in which a connecting hole is formed in a circumferential surface of the inner housing; and
a flow passage formed between an inner circumferential surface of the outer housing and an outer circumferential surface of the inner housing to guide the air introduced through the connecting hole to be discharged through the discharge port.

7. The vacuum cleaner of claim 6, wherein the housing includes:
a body which is coupled to an air inlet side of the outer housing or the inner housing and in which a discharge hole is formed and a motor member is fixedly installed to correspond to the discharge hole; and
a discharge filter module which is installed in the outer housing to correspond to the discharge port to purify exhausted air and prevent external foreign matter from being introduced into the outer housing.

8. The vacuum cleaner of claim 7, wherein the discharge filter module includes:
a frame which is slide-inserted into the discharge port to a set depth and formed to allow air to pass;
one or more foreign matter filters provided inside the frame; and
an odor filter which is provided on at least one of an inlet side and an outlet side of the frame, through which air in the outer housing is introduced, to filter out particles and an odor material generated when the motor member is driven.

9. The vacuum cleaner of claim 8, wherein the discharge filter module includes a cover separably coupled to the outer housing to allow air to flow and prevent the frame from being separated from the discharge port due to flow resistance of the exhausted air.

10. The vacuum cleaner of claim 8, wherein the frame includes a knob to be gripped when taken out of the discharge port.

11. The vacuum cleaner of claim 6, wherein:
the outer housing includes a rotary reel which is rotatable in an inner space partitioned from the inner housing; and
the rotary reel is rotated using a handle and winds a cable which is withdrawn.

12. The vacuum cleaner of claim 6, wherein the outer housing includes a pivoting grip.

13. The vacuum cleaner of claim 11, wherein the housing includes a guide roller at an inner side corresponding to an outlet hole to guide the cable.
